(19) United States
(12) Patent Application Publication
(10) Pub. No.: US 2021/0130583 A1
(43) Pub. Date: May 6, 2021

(54) REINFORCED POLYPHTHALAMIDE/POLYPHENYLENE ETHER COMPOSITION, METHOD FOR THE MANUFACTURE THEREOF, AND ARTICLES PREPARED THEREFROM

(71) Applicant: SHPP Global Technologies B.V., Bergen op Zoom (NL)

(72) Inventors: Siguang JIANG, Shanghai (CN); Wei ZHANG, Shanghai (CN)

(21) Appl. No.: 17/251,278

(22) PCT Filed: Jun. 25, 2019
(86) PCT No.: PCT/IB2019/055363

§ 371 Date: Dec. 11, 2020

(30) Foreign Application Priority Data
Jul. 2, 2018 (EP) 18181148.0

(51) Int. Cl. C08K 7/14; C08L 71/12; C08L 77/02; C08K 5/092; C08L 53/02

(52) U.S. Cl. CPC C08K 7/14; C08L 71/12; C08L 53/02; C08K 5/092; C08L 77/02

(57) ABSTRACT

A reinforced composition includes particular amounts of a compatibilized blend including a polyamide, a polyphenylene ether, a functionalizing agent in an amount sufficient to effect compatibilization, and optionally, a high impact polystyrene, wherein a weight ratio of the polyamide to the polyphenylene ether and the high impact polystyrene is 1:2 to 3:1. The reinforced composition further includes of glass fibers having a dielectric constant of less than 5.0 at a frequency of 1 MHz to 1 GHz and a dissipation factor of less than 0.002 at a frequency of 1 MHz to 1 GHz. The composition has a dielectric constant of less than 4 at a frequency of 1 MHz to 5 GHz and a dissipation factor of less than 0.012 at a frequency of 1 MHz to 5 GHz.

### BACKGROUND

Dielectric performance is one consideration in selecting suitable plastic materials for use in electronics and telecommunication applications. It would be desirable to provide materials suitable for exposure to high frequency environments (e.g., in the range of 10-100 GHz). Polymeric materials with a higher dielectric constant (Dk) and dissipation factor (Df) will absorb substantially more electromagnetic energy, affecting the strength and phase of the electromagnetic wave.

In addition to dielectric performance, however, plastics for use in such components should also have certain mechanical performance characteristics including high modulus and high impact strength. Improved mechanical performance can be imparted to polymeric materials by the addition of fillers such as glass fiber, carbon fiber and ceramics. However, typical fillers tend towards elevated dielectric performance (Dk and DO properties.

Thus, there is a continuing need for new compositions that can address the above-described technical limitations. Specifically, it would be particularly useful to provide a composition having good dielectric performance while also maintaining good mechanical properties.

### BRIEF DESCRIPTION

A reinforced composition comprises 40 to 80 weight percent of a compatibilized blend comprising a polyamide; a polyphenylene ether, a high impact polystyrene, or a combination thereof; and a functionalizing agent in an amount sufficient to effect compatibilization, wherein a weight ratio of the polyamide to the polyphenylene ether and the high impact polystyrene is 1:2 to 3:1; and 20 to 60 weight of glass fibers having a dielectric constant of less than 5.0 at a frequency of 1 MHz to 1 GHz and a dissipation factor of less than 0.002 at a frequency of 1 MHz to 1 GHz; wherein weight percent of each component is based on the total weight of the composition; and wherein the composition has a dielectric constant of less than 4 at a frequency of 1 MHz to 5 GHz and a dissipation factor of less than 0.012 at a frequency of 1 MHz to 5 GHz.

A method for the manufacture of the reinforced composition comprises melt-mixing the components of the reinforced composition; and optionally, extruding the reinforced composition.

An article comprises the reinforced composition.

The above described and other features are exemplified by the following detailed description.

### DETAILED DESCRIPTION

The present inventors have discovered that a composition comprising particular amounts of a compatibilized blend of polyamide and polyphenylene ether and glass fibers having a low dielectric constant (Dk) and low dissipation factor (Df) can advantageously exhibit exceptional dielectric performance while good maintaining mechanical properties.

Accordingly, as aspect of the present disclosure is a reinforced composition. The composition comprises a compatibilized blend comprising a polyamide; a polyphenylene ether, a high impact polystyrene, or a combination thereof; and a functionalizing agent in an amount sufficient to effect compatibilization.

Polyamides, also known as nylons, are characterized by the presence of a plurality of amide (—C(O)NH—) groups and are described in U.S. Pat. No. 4,970,272 to Gallucci. The polyamide can include aliphatic polyamides, aromatic polyamides, semi-aromatic polyamides, polyamide elastomers, and mixtures thereof. In some embodiments, the polyamide comprises an aromatic polyamide. In some embodiments, the polyamide comprises a poly(C₁₋₁₂ alkylene dicarboxylate). Specific polyamides include polyamide-6, polyamide-6,6, polyamide-4, polyamide-4,6, polyamide-12, polyamide-6,10, polyamide-6,9, polyamide-6,12, amorphous polyamides, polyamide-6/6T and polyamide-6,6/6T with triamine contents below 0.5 weight percent, polyamide-9T, polyamide-10,10, polyphthalamide, and combinations thereof. In some embodiments, the polyamide comprises a polyamide-10, a polyamide-10,10, or a mixture thereof. In some embodiments, the polyamide comprises a polyamide-10,10. In some embodiments, the polyamide comprises a polyamide-10 and a polyamide-10,10. Polyamides are commercially available from a variety of sources.

In some embodiments, the polyamide comprises a polyphthalamide. Polyphthalamides comprise repeating units having the formula

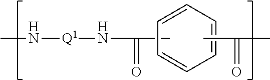

wherein Q¹ is independently at each occurrence a branched or unbranched alicyclic C₄₋₈ alkyl group. In some embodiments, Q¹ is independently at each occurrence a 1,6-hexyl group. Polyphthalamides are the condensation product of terephthalic acid and an amine, isophthalic acid and an amine or a combination of terephthalic acid, isophthalic acid and an amine. When employing more than one diamine the ratio of the diamines can affect some of the physical properties of the resulting polymer such as the melt temperature. When employing more than one acid, the ratio of the acids can affect some of the physical properties of the resulting polymer as well. The ratio of diamine to dicarboxylic acid is typically equimolar although excesses of one or the other can be used to determine the end group functionality. In addition the reaction can further include monoamines and monocarboxylic acids which function as chain stoppers and determine, at least in part, the end group functionality. In some embodiments it is preferable to have an amine end group content of greater than or equal to about 30 milliequivalents per gram (meq/g), or, more specifically, greater than or equal to about 40 meq/g.

In some embodiments the polyphthalamide is a block copolymer or a random copolymer further comprising units of the formula

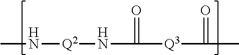

wherein Q² and Q³ are independently at each occurrence a branched or unbranched alicyclic C₄₋₁₂ alkyl group. Q² and Q³ can be the same or different alicyclic C₄₋₁₂ alkyl group.

The polyphthalamide has a glass transition temperature (Tg) greater than or equal to 80° C., or, greater than or equal to 100° C., or, greater than or equal to 120° C. The polyphthalamide also has melting temperature (Tm) of 290 to 330° C. Within this range the Tm can be greater than or equal to 300° C. Also within this range the Tm can be less than or equal to 325° C.

The polyamide can be present in an amount of 15 to 60 weight percent, based on the total weight of the composition. Within this range, the amount of the polyamide can be greater than or equal to 20 weight percent, or greater than or equal to 30 weight percent. Also within this range, the amount of the polyamide can be less than or equal to 55 weight percent, or less than or equal to 45 weight percent. In a specific embodiment, the polyamide can be present in an amount of 32 to 50 weight percent. In another specific embodiment, the polymer can be present in an amount of 15 to 45 weight percent.

In addition to the polyamide, the compatibilized blend comprises a polyphenylene ether, a high impact polystyrene, or a combination thereof. Suitable polyphenylene ethers include those comprising repeating structural units having the formula

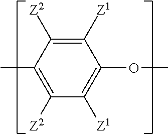

wherein each occurrence of Z¹ is independently halogen, unsubstituted or substituted C₁₋₁₂ hydrocarbyl provided that the hydrocarbyl group is not tertiary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms; and each occurrence of Z² is independently hydrogen, halogen, unsubstituted or substituted C₁₋₁₂ hydrocarbyl provided that the hydrocarbyl group is not tertiary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms. As one example, Z¹ can be a di-n-butylaminomethyl group formed by reaction of a terminal 3,5-dimethyl-1,4-phenyl group with the di-n-butylamine component of an oxidative polymerization catalyst.

The polyphenylene ether can comprise molecules having aminoalkyl-containing end group(s), typically located in a position ortho to the hydroxy group. Also frequently present are tetramethyldiphenoquinone (TMDQ) end groups, typically obtained from 2,6-dimethylphenol-containing reaction mixtures in which tetramethyldiphenoquinone by-product is present. The polyphenylene ether can be in the form of a homopolymer, a copolymer, a graft copolymer, an ionomer, or a block copolymer, as well as combinations thereof.

In some embodiments, the polyphenylene ether has an intrinsic viscosity of 0.25 to 1 deciliter per gram measured by Ubbelohde viscometer at 25° C. in chloroform. Within this range, the polyphenylene ether intrinsic viscosity can be 0.3 to 0.65 deciliter per gram, more specifically 0.35 to 0.5 deciliter per gram, even more specifically 0.4 to 0.5 deciliter per gram.

In some embodiments, the polyphenylene ether comprises a homopolymer or copolymer of monomers selected from the group consisting of 2,6-dimethylphenol, 2,3,6-trimethylphenol, and combinations thereof. In some embodiments, the polyphenylene ether comprises a poly(2,6-dimethyl-1,4-phenylene ether) having an intrinsic viscosity of about 0.35 to about 0.5 deciliter per gram, specifically about 0.35 to about 0.46 deciliter per gram, measured at 25° C. in chloroform. In some embodiments, the polyphenylene ether comprises a copolymer of 2,6-dimethylphenol and 2,3,6-trimethylphenol. In some embodiments, the copolymer of 2,6-dimethylphenol and 2,3,6-trimethylphenol can comprise about 5 to about 30 weight percent of 2,3,6-trimethyl-1,4-phenylene ether repeat units, and about 70 to about 95 weight percent of 2,6-dimethyl-1,4-phenylene ether repeat units. Suitable polyphenylene ether homopolymers are commercially available as, for example, PPO™ 640 and 646 from SABIC, and XYRON™ S201A and S202A from Asahi Kasei Chemicals Corporation.

The polyphenylene ether can be prepared by the oxidative coupling of monohydroxyaromatic compound(s) such as 2,6-xylenol and/or 2,3,6-trimethylphenol. Catalyst systems are generally employed for such coupling; they can contain heavy metal compound(s) such as a copper, manganese or cobalt compound, usually in combination with various other materials such as a secondary amine, tertiary amine, halide or combination of two or more of the foregoing.

A portion of the polyphenylene ether can be functionalized with a polyfunctional compound (functionalizing agent) as described below. The polyphenylene ether can be functionalized prior to making the composition or can be functionalized as part of making the composition. Furthermore, prior to functionalization the polyphenylene ether can be extruded, for example to be formed into pellets. It is also possible for polyphenylene ether to be melt mixed with other additives that do not interfere with functionalization. Exemplary additives of this type include flow promoters and the like.

In some embodiments the polyphenylene ether can comprise 0.1 weight percent weight percent to 90 weight percent of structural units derived from a functionalizing agent, based on the total weight of the polyphenylene ether. Within this range, the polyphenylene ether can comprise less than or equal to 80 weight percent, or, more specifically, less than or equal to 70 weight percent of structural units derived from functionalizing agent, based on the total weight of the polyphenylene ether.

The polyphenylene ether can have a number average molecular weight of 3,000 to 40,000 grams per mole (g/mol) and a weight average molecular weight of 5,000 to 80,000 g/mol, as determined by gel permeation chromatography using monodisperse polystyrene standards, a styrene divinyl benzene gel at 40° C. and samples having a concentration of 1 milligram per milliliter of chloroform. The polyphenylene ether or combination of polyphenylene ethers has an initial intrinsic viscosity of 0.1 to 0.60 deciliters per gram (dl/g), as measured in chloroform at 25° C. Initial intrinsic viscosity is defined as the intrinsic viscosity of the poly(phenylene ether) prior to melt mixing with the other components of the composition and final intrinsic viscosity is defined as the intrinsic viscosity of the polyphenylene ether after melt mixing with the other components of the composition. As understood by one of ordinary skill in the art the viscosity of the polyphenylene ether can be up to 30% higher after melt mixing. The percentage of increase can be calculated by (final intrinsic viscosity−initial intrinsic viscosity)/initial intrinsic viscosity. Determining an exact ratio, when two initial intrinsic viscosities are used, will depend somewhat on the exact intrinsic viscosities of the polyphenylene ether used and the ultimate physical properties that are desired

The compatibilized blend can include the polyphenylene ether in an amount of 4 to 40 weight percent, based on the total weight of the composition. Within this range, the amount of the polyphenylene ether can be greater than or equal to 8 weight percent, or greater than or equal to 15 weight percent, or greater than or equal to 25 weight percent. Also within this range, the amount of the polyphenylene ether can be less than or equal to 35 weight percent, or less than or equal to 30 weight percent, or less than or equal to 15 weight percent, or less than or equal to 10 weight percent. In a specific embodiment, the amount of the polyphenylene ether can be 25 to 40 weight percent. In another specific embodiment, the amount of the polyphenylene ether can be 4 to 10 weight percent.

The compatibilized blend is formed using a functionalizing agent. When used herein, the expression “functionalizing agent” refers to polyfunctional compounds which interact with the polyphenylene ether, the polyamide resin, or both. This interaction can be chemical (e.g., grafting) or physical (e.g., affecting the surface characteristics of the dispersed phases). In either instance the resulting compatibilized polyphthalamide/polyphenylene ether composition appears to exhibit improved compatibility, particularly as evidenced by enhanced impact strength, mold knit line strength or elongation. As used herein, the expression “compatibilized polyphthalamide/polyphenylene ether blend” refers to those compositions which have been physically and/or chemically compatibilized with a functionalizing agent.

The functionalizing agent comprises a polyfunctional compound that is one of two types. The first type has in the molecule both (a) a carbon-carbon double bond and (b) at least one carboxylic acid, anhydride, epoxy, imide, amide, ester group or functional equivalent thereof. Examples of such polyfunctional compounds include maleic acid; maleic anhydride; fumaric acid; maleic hydrazide; dichloro maleic anhydride; and unsaturated dicarboxylic acids (e.g. acrylic acid, butenoic acid, methacrylic acid, t-ethylacrylic acid, pentenoic acid). In some embodiments, the functionalizing agent comprises maleic anhydride or fumaric acid.

The second type of polyfunctional functionalizing agent compounds are characterized as having both (a) a group represented by the formula (OR) wherein R is hydrogen or a C₁₋₁₂ alkyl, C₆₋₂₀ aryl, C₂₋₁₂ acyl or carbonyl dioxy group and (b) at least two groups each of which can be the same or different selected from carboxylic acid, acid halide, anhydride, acid halide anhydride, ester, orthoester, amide, imido, amino, and salts thereof. Typical of this type of functionalizing agents are the aliphatic polycarboxylic acids, acid esters and acid amides represented by the formula

(R^{I}O)ₘR(COOR^{II})ⁿ(CONR^{III}R^{IV})ₛ

wherein R is a linear or branched chain saturated aliphatic hydrocarbon having 2 to 20, or, more specifically, 2 to 10 carbon atoms; R^{I} is hydrogen or an alkyl, aryl, acyl or carbonyl dioxy group having 1 to 10, or, more specifically, 1 to 6, or, even more specifically, 1 to 4 carbon atoms; each R^{II} is independently hydrogen or an alkyl or aryl group having 1 to 20, or, more specifically, 1 to 10 carbon atoms; each R^{III} and R^{IV} are independently hydrogen or an alkyl or aryl group having 1 to 10, or, more specifically 1 to 6, or, even more specifically, 1 to 4, carbon atoms; m is equal to 1 and (n+s) is greater than or equal to 2, or, more specifically, equal to 2 or 3, and n and s are each greater than or equal to zero and wherein (OR) is alpha or beta to a carbonyl group and at least two carbonyl groups are separated by 2 to 6 carbon atoms. Obviously, R^{I}, R^{II}, R^{III} and R^{IV} cannot be aryl when the respective substituent has less than 6 carbon atoms.

Suitable polycarboxylic acids include, for example, citric acid, malic acid, agaricic acid; including the various commercial forms thereof, such as for example, the anhydrous and hydrated acids; and combinations comprising one or more of the foregoing. In some embodiments, the functionalizing agent comprises citric acid. Illustrative esters useful herein include, for example, acetyl citrate and mono- and/or distearyl citrates and the like. Suitable amides useful herein include, for example, N,N′-diethyl citric acid amide; N-phenyl citric acid amide; N-dodecyl citric acid amide; N,N′-didodecyl citric acid amide and N-dodecyl malic acid. Derivatives include the salts thereof, including the salts with amines and the alkali and alkaline metal salts. Exemplary suitable salts include calcium malate, calcium citrate, potassium malate, and potassium citrate.

The foregoing functionalizing agents can be added directly to the melt blend or pre-reacted with either or both the polyphenylene ether and polyamide. In some embodiments, at least a portion of the functionalizing agent is pre-reacted, either in the melt or in a solution of a suitable solvent, with all or a part of the polyphenylene ether. It is believed that such pre-reacting can cause the functionalizing agent to react with the polymer and, consequently, functionalize the polyphenylene ether. For example, the polyphenylene ether can be pre-reacted with maleic anhydride, fumaric acid or citric acid to form an anhydride or acid functionalized polyphenylene ether which has improved compatibility with the polyamide compared to a non-functionalized polyphenylene ether.

The amount of the functionalizing agent used will be dependent upon the specific functionalizing agent chosen and the specific polymeric system to which it is added.

In some embodiments, the functionalizing agent is employed in an amount of 0.05 to 2.0 weight percent, based on the total weight of the composition. Within this range the amount of functionalizing agent can be greater than or equal to 0.1, or, more specifically, greater than or equal to 0.2, or, more specifically, greater than or equal to 0.3 weight percent. Also within this range the amount of functionalizing agent can be less than or equal to 1.75, or, more specifically, less than or equal to 1.5 weight percent, or, more specifically less than or equal to 0.9 weight percent.

The compatibilized blend can optionally further include a high impact polystyrene, which can also be referred to as a rubber-modified polystyrene. In some embodiments, the high impact polystyrene can be used in combination with the polyphenylene ether. In some embodiments, the high impact polystyrene can be used in place of the polyphenylene ether. In some embodiments, no high impact polystyrene is present.

High impact polystyrene (“HIPS”) comprises polystyrene and polybutadiene. In some embodiments, the high impact polystyrene comprises 80 to 96 weight percent polystyrene, specifically 88 to 94 weight percent polystyrene; and 4 to 20 weight percent polybutadiene, specifically 6 to 12 weight percent polybutadiene, based on the weight of the rubber-modified polystyrene. In some embodiments, the high impact polystyrene has an effective gel content of 10 to 35 percent. Suitable high impact polystyrenes are commercially available as, for example, HIPS3190 from SABIC.

When present, the high impact polystyrene can be present in an amount of 1 to 20 weight percent, based on the total weight of the composition. Within this range, the amount of the high impact polystyrene can be 2 to 12 weight percent, or 3 to 10 weight percent or, or 4 to 10 weight percent, or 4 to 9.5 weight percent.

The polyamide, the polyphenylene ether, and the high impact polystyrene can be present in the aforementioned amounts provided that the weight ratio of the polyamide to the polyphenylene ether and the high impact polystyrene (i.e., weight ratio of polyamide:(polyphenylene ether+high impact polystyrene) is 1:2 to 3:1.

In a specific embodiment, the compatibilized blend comprises the polyamide and the polyphenylene ether, preferably wherein the compatibilized blend comprises 20 to 60 weight percent of the polyamide and 10 to 40 weight percent of the polyphenylene ether. In another specific embodiment, the compatibilized blend comprises the polyamide, the polyphenylene ether, and the high impact polystyrene, preferably wherein the compatibilized blend comprises 20 to 60 weight percent of the polyamide, 1 to 39 weight percent of the polyphenylene ether, and 1 to 20 weight percent of the high impact polystyrene.

In addition to the compatibilized blend, the reinforced composition of the present disclosure further comprises a low dielectric constant (Dk)/low dissipation factor (Df) glass fiber component. The glass fiber component can be E-glass, S-glass, AR-glass, T-glass, D-glass or R-glass. Preferably, the glass fiber has a dielectric constant of less than 5 at a frequency of from 1 MHz to 1 GHz and a Df of less than 0.002 at a frequency of from 1 MHz to 1 GHz. In a further aspect the glass fiber has a Df of less than 0.0001 at a frequency of 1 MHz to 1 GHz. The glass fibers can be made, for example, by steam or air blowing, flame blowing, and mechanical pulling. Exemplary glass fibers for the compositions of the present disclosure can be made by mechanical pulling.

The glass fibers can be sized or unsized. Sized glass fibers are coated on their surfaces with a sizing composition selected for compatibility with the compatibilized blend. The sizing composition facilitates wet-out and wet-through of the polyamide/polyphenylene ether blend upon the fiber strands and assists in attaining desired physical properties in the reinforced composition.

In some embodiments, the glass fiber is sized with a coating agent. For example, the coating agent can be present in an amount of 0.1 to 5 wt. % based on the weight of the glass fibers, or 0.1 to 2 wt. % based on the weight of the glass fibers.

In preparing the glass fibers, a number of filaments can be formed simultaneously, sized with the coating agent and then bundled into a strand. Alternatively the strand itself can be first formed of filaments and then sized. The amount of sizing employed is generally that amount which is sufficient to bind the glass filaments into a continuous strand and can be, for example, 0.1 to 5 wt. %, or 0.1 to 5 wt. %, or 0.1 to 2 wt. %, or 0.1 to 2 wt. % based on the weight of the glass fibers.

The glass fibers can be continuous or chopped. The glass fiber can preferably be chopped. Glass fibers in the form of chopped strands can have a length of 0.3 millimeters (mm) to 10 centimeters (cm) or 0.5 mm to 5 cm or 0.5 millimeter to 5 centimeters, or 1.0 mm to 2.5 cm, or 0.2 to 20 mm, or 0.2 to 10 mm, or 0.7 to 7 mm, or 0.7 to 7 mm.

The glass fiber can have a round (or circular), flat, or irregular cross-section. In some embodiments, the glass fiber has a circular cross-section. In some embodiments, the diameter of the glass fiber is 1 to 20 micrometer (micron, μm), or 4 to 15 μm, or 1 to 15 μm, or 7 to 15 μm.

The reinforced composition includes 20 to 60 weight percent of the glass fiber component. Within this range, the amount of the glass fibers can be 25 to 55 weight percent, or 30 to 50 weight percent.

The glass fibers are low dielectric constant (Dk)/low dissipation factor (Df) glass fiber. Specifically, the glass fibers have a Dk of less than 5.0 at a frequency of from 1 MHz to 1 GHz and a Df of less than 0.002 at a frequency of from 1 MHz to 1 GHz. In a further aspect the glass fiber has a Df of less than 0.0001 at a frequency of 1 MHz to 1 GHz.

In a specific embodiment, glass fibers suitable for use can include, but are not limited to, the HL-glass fibers ECS303N-3-K/HL and/or ECS301HP-3-K/HL, available from Chongqing Polycomp International Corp. (CPIC). This fiber has a Dk of 4.6 at 1 MHz and a Df of less than 0.001 at 1 MHz, each when tested in accordance with IEC 60250-1969.

In addition to the compatibilized blend and the glass fibers, the reinforced composition can optionally further include an impact modifier. The impact modifier is preferably a hydrogenated block copolymer of an alkenyl aromatic monomer and a conjugated diene. For brevity, this component is referred to as the “hydrogenated block copolymer”. The hydrogenated block copolymer can comprise 10 to 90 weight percent of poly(alkenyl aromatic) content and 90 to 10 weight percent of hydrogenated poly(conjugated diene) content, based on the weight of the hydrogenated block copolymer. In some embodiments, the hydrogenated block copolymer is a low poly(alkenyl aromatic content) hydrogenated block copolymer in which the poly(alkenyl aromatic) content is 10 to less than 40 weight percent, or 20 to 35 weight percent, or 25 to 35 weight percent, yet or 30 to 35 weight percent, all based on the weight of the low poly(alkenyl aromatic) content hydrogenated block copolymer. In other embodiments, the hydrogenated block copolymer is a high poly(alkenyl aromatic content) hydrogenated block copolymer in which the poly(alkenyl aromatic) content is 40 to 90 weight percent, or 50 to 80 weight percent, or 60 to 70 weight percent, all based on the weight of the high poly(alkenyl aromatic content) hydrogenated block copolymer.

In some embodiments, the hydrogenated block copolymer has a weight average molecular weight of 40,000 to 400,000 grams per mole. The number average molecular weight and the weight average molecular weight can be determined by gel permeation chromatography and based on comparison to polystyrene standards. In some embodiments, the hydrogenated block copolymer has a weight average molecular weight of 200,000 to 400,000 grams per mole, or 220,000 to 350,000 grams per mole. In other embodiments, the hydrogenated block copolymer has a weight average molecular weight of 40,000 to 200,000 grams per mole, or 40,000 to 180,000 grams per mole, or 40,000 to 150,000 grams per mole.

The alkenyl aromatic monomer used to prepare the hydrogenated block copolymer can have the structure

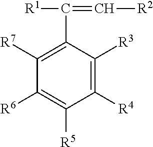

wherein R¹ and R² each independently represent a hydrogen atom, a C₁₋₈ alkyl group, or a C₂₋₈ alkenyl group; R³ and R⁷ each independently represent a hydrogen atom, a C₁₋₈ alkyl group, a chlorine atom, or a bromine atom; and R⁴, R⁵, and R⁶ each independently represent a hydrogen atom, a C₁₋₈ alkyl group, or a C₂₋₈ alkenyl group, or R⁴ and R⁵ are taken together with the central aromatic ring to form a naphthyl group, or R⁵ and R⁶ are taken together with the central aromatic ring to form a naphthyl group. Specific alkenyl aromatic monomers include, for example, styrene, chlorostyrenes such as p-chlorostyrene, methylstyrenes such as alpha-methylstyrene and p-methylstyrene, and t-butylstyrenes such as 3-t-butylstyrene and 4-t-butylstyrene. In some embodiments, the alkenyl aromatic monomer is styrene.

The conjugated diene used to prepare the hydrogenated block copolymer can be a C₄₋₂₀ conjugated diene. Suitable conjugated dienes include, for example, 1,3-butadiene, 2-methyl-1,3-butadiene, 2-chloro-1,3-butadiene, 2,3-dimethyl-1,3-butadiene, 1,3-pentadiene, 1,3-hexadiene, and the like, and combinations thereof. In some embodiments, the conjugated diene is 1,3-butadiene, 2-methyl-1,3-butadiene, or a combination thereof. In some embodiments, the conjugated diene is 1,3-butadiene.

The hydrogenated block copolymer is a copolymer comprising (A) at least one block derived from an alkenyl aromatic compound and (B) at least one block derived from a conjugated diene, in which the aliphatic unsaturated group content in the block (B) is at least partially reduced by hydrogenation. In some embodiments, the aliphatic unsaturation in the (B) block is reduced by at least 50 percent, or at least 70 percent. The arrangement of blocks (A) and (B) includes a linear structure, a grafted structure, and a radial teleblock structure with or without a branched chain. Linear block copolymers include tapered linear structures and non-tapered linear structures. In some embodiments, the hydrogenated block copolymer has a tapered linear structure. In some embodiments, the hydrogenated block copolymer has a non-tapered linear structure. In some embodiments, the hydrogenated block copolymer comprises a (B) block that comprises random incorporation of alkenyl aromatic monomer. Linear block copolymer structures include diblock (A-B block), triblock (A-B-A block or B-A-B block), tetrablock (A-B-A-B block), and pentablock (A-B-A-B-A block or B-A-B-A-B block) structures as well as linear structures containing 6 or more blocks in total of (A) and (B), wherein the molecular weight of each (A) block can be the same as or different from that of other (A) blocks, and the molecular weight of each (B) block can be the same as or different from that of other (B) blocks. In some embodiments, the hydrogenated block copolymer is a diblock copolymer, a triblock copolymer, or a combination thereof.

In some embodiments, the hydrogenated block copolymer excludes the residue of monomers other than the alkenyl aromatic compound and the conjugated diene. In some embodiments, the hydrogenated block copolymer consists of blocks derived from the alkenyl aromatic compound and the conjugated diene. It does not comprise grafts formed from these or any other monomers. It also consists of carbon and hydrogen atoms and therefore excludes heteroatoms. In some embodiments, the hydrogenated block copolymer includes the residue of one or more acid functionalizing agents, such as maleic anhydride. In some embodiments, the hydrogenated block copolymer comprises a polystyrene-poly(ethylene-butylene)-polystyrene triblock copolymer, a polystyrene-poly(ethylene-propylene) diblock copolymer, or a combination thereof.

In some embodiments, the hydrogenated block copolymer is a polystyrene-poly(ethylene-butylene)-polystyrene triblock copolymer having a polystyrene content of 25 to 35 weight percent, based on the weight of the polystyrene-poly(ethylene-butylene)-polystyrene triblock copolymer. In some embodiments, the hydrogenated block copolymer is a polystyrene-poly(ethylene-propylene) diblock copolymer having a polystyrene content of 35 to 55 weight percent, based on the weight of the polystyrene-poly(ethylene-propylene) diblock copolymer.

Methods for preparing hydrogenated block copolymers are known in the art and many hydrogenated block copolymers are commercially available. Illustrative commercially available hydrogenated block copolymers include the polystyrene-poly(ethylene-propylene) diblock copolymers available from Kraton Performance Polymers Inc. as KRATON™ G1701 (having 37 weight percent polystyrene) and G1702 (having 28 weight percent polystyrene); the polystyrene-poly(ethylene-butylene)-polystyrene triblock copolymers available from Kraton Performance Polymers Inc. as KRATON™ G1641 (having 33 weight percent polystyrene), G1650 (having 30 weight percent polystyrene), G1651 (having 33 weight percent polystyrene), and G1654 (having 31 weight percent polystyrene); and the polystyrene-poly(ethylene-ethylene/propylene)-polystyrene triblock copolymers available from Kuraray as SEPTON™ S4044, S4055, S4077, and S4099. Additional commercially available hydrogenated block copolymers include polystyrene-poly(ethylene-butylene)-polystyrene (SEBS) triblock copolymers available from Dynasol as CALPRENE™ H6140 (having 31 weight percent polystyrene), H6170 (having 33 weight percent polystyrene), H6171 (having 33 weight percent polystyrene), and H6174 (having 33 weight percent polystyrene); and from Kuraray as SEPTON™ 8006 (having 33 weight percent polystyrene) and 8007 (having 30 weight percent polystyrene); polystyrene-poly(ethylene-propylene)-polystyrene (SEPS) copolymers available from Kuraray as SEPTON™ 2006 (having 35 weight percent polystyrene) and 2007 (having 30 weight percent polystyrene); and oil-extended compounds of these hydrogenated block copolymers available from Kraton Performance Polymers Inc. as KRATON™ G4609 (containing 45% mineral oil, and the SEBS having 33 weight percent polystyrene) and G4610 (containing 31% mineral oil, and the SEBS having 33 weight percent polystyrene); and from Asahi as TUFTEC™ H1272 (containing 36% oil, and the SEBS having 35 weight percent polystyrene). Mixtures of two of more hydrogenated block copolymers can be used. In some embodiments, the hydrogenated block copolymer comprises a polystyrene poly(ethylene-butylene)-polystyrene triblock copolymer having a weight average molecular weight of at least 100,000 grams per mole, or 200,000 to 400,000 grams per mole.

When present, the composition comprises the hydrogenated block copolymer in an amount of 0.1 to 10 weight percent, based on the total weight of the composition. Within this range, the hydrogenated block copolymer amount can be 0.5 to 10 weight percent, or 1 to 9 weight percent.

The composition can, optionally, further comprise one or more other additives. Useful additives include, for example, an antioxidant, heat stabilizer, light stabilizer, ultraviolet light stabilizer, ultraviolet light absorbing additive, plasticizer, lubricant, release agent, processing aid, antistatic agent, anti-fog agent, antimicrobial agent, colorant, surface effect additive, radiation stabilizer, flame retardant, anti-drip agent, hydrostabilizer, or a combination comprising at least one of the foregoing. In some embodiments, the composition can further comprise an antioxidant, heat stabilizer, hydrostabilizer, ultraviolet light stabilizer, processing aid, or a combination comprising at least one of the foregoing. Additives can be added in amounts that do not unacceptably detract from the desired performance and physical properties of the composition. Generally, the total amount of additives will be less than or equal to 5 weight percent based on the total weight of the composition.

In an aspect, the composition can optionally exclude a laser direct structuring additive, for example a metal oxide, and in particular a metal oxide comprising magnesium, copper, cobalt, tin, titanium, iron, aluminum, chromium, and the like, or a combination thereof. Other laser direct structuring additives that can be excluded from the present composition can also include mixed metal oxides, metal phosphate, metal hydroxide oxides, metal hydroxide phosphate, and metal sulfide oxides. Specific laser direct structuring additives that can be excluded from the present composition can include, for example, copper chromium oxide, copper oxide, copper hydroxide phosphate, tin hydroxide phosphate, tin phosphate, copper phosphate, basic copper phosphates, tin phosphates, and the like, or a combination thereof.

Advantageously, the reinforced composition of the present disclosure exhibits good dielectric properties. For example, the composition has a dielectric constant (Dk) of less than 4 at a frequency of 1 MHz to 1 GHz and a dissipation factor (DO of less than 0.012 at a frequency of 1 MHz to 1 GHz. Furthermore, the composition of the present disclosure maintains good mechanical performance and processing properties. Mechanical and processing properties of interest include, but are not limited to, notched and unnotched Izod impact strength (tested in accordance with ASTM D256), flexural modulus and flexural strength (tested in accordance with ASTM D790), and tensile modulus/strength/elongation (tested in accordance with ASTM D638), as further described in the working examples below.

The composition can be prepared by melt-blending or melt-kneading the components of the composition. The melt-blending or melt-kneading can be performed using common equipment such as ribbon blenders, HENSCHEL™ mixers, BANBURY™ mixers, drum tumblers, single-screw extruders, twin-screw extruders, multi-screw extruders, co-kneaders, and the like. For example, the present composition can be prepared by melt-blending the components in a twin-screw extruder at a temperature of 270 to 310° C., or 280 to 300° C.

The composition is also useful for forming a variety of articles, including automotive, electrical, and electronic components. In some embodiments, the composition is useful for forming a component of a consumer electronic device. Suitable methods of forming such articles include single layer and multilayer sheet extrusion, injection molding, blow molding, film extrusion, profile extrusion, pultrusion, compression molding, thermoforming, pressure forming, hydroforming, vacuum forming, and the like. Combinations of the foregoing article fabrication methods can be used.

This disclosure is further illustrated by the following examples, which are non-limiting.

### Examples

The materials used for the following Examples are described in Table 1.

TABLE 1

| Component | Description | Supplier |
|---|---|---|
| PPA | Polyphthalamide, PA6T/66, obtained as NHU600 | NHU |
| PPE | Poly(2,6-dimethyl-1,4-phenylene ether), CAS Reg. No. 24938-67-8, | SABIC |
| | having an intrinsic viscosity of 0.46 deciliter per gram as measured in | |
| | chloroform at 25° C.; obtained as PPO 646 | |
| PA1010 | Polyamide-10,10, having a melting point of 265° C.; obtained as | Arkema |
| | RILSAN TMNO | |
| HIPS | High-impact polystyrene (rubber-modified polystyrene), CAS Reg. No. | Idemitsu |
| | 9003-55-8, having a rubber content of 10.3 weight percent, and a | |
| | mineral oil content of 1.5 weight percent; obtained as ET60 from | |
| | Idemitsu. | |
| GF | Glass fibers having a Dk of less than 5.0 and and a Df of less than 0.002 | CPIC |
| | at a frequency of 1 MHz to 1 GHz, and having a diameter of 13 um | |
| SEBS | Polystyrene-poly(ethylene-butylene)-polystyrene triblock copolymer, | Kraton |
| | CAS Reg. No. 66070-58-4, having a polystyrene content of 30-33 | |
| | weight percent and a negligible melt flow, measured at 260° C. and 5 | |
| | kilogram load according to ASTM D1238; obtained as KRATON | |
| | G1651 | |
| SEP | Polystyrene-poly(ethylene-propylene) diblock copolymer (CAS Reg. | Kraton |
| | No. 68648-89-5) having a polystyrene content of 37 weight percent; | |
| | obtained from Kraton Polymers as KRATON G1701. | |
| AO-1 | Irganox 1010, 6683-19-8 | BASF |
| AO-2 | Pentaerythritol Diphosphite, Ultranox 626, 26741-53-7 | Lanxess |
| Ca Stearate | Calcium stearate obtained at SYNPRO Ca Stearate 15F | Valtris |
| AO-3 | Reaction products of phosphorus trichloride with 1,1′-biphenyl and 2,4- | Clariant |
| | bis(1,1-dimethylethyl)phenol, CAS Reg. No. 119345-01-6; obtained as | |
| | HOSTANOX ™ P-EPQ ™ | |
| AO-4 | Octadecyl 3,5-di-tert-butyl-4-hydroxyhydrocinnamate, CAS Reg. No. | BASF |
| | 2082-79-3; obtained as IRGANOX 1076 | |
| Citric acid | Citric acid, CAS Reg. No. 77-92-9 | Intercontinental |

For each example, all components were blended together and extruded on a 37 millimeter twin-screw extruder using the parameters summarized in Table 2.

TABLE 2

| Parameters | Unit | Ex. 1-9 | Ex. 10 | Ex. 11 |
|---|---|---|---|---|
| Zone 1 Temp | ° C. | 50 | 50 | 50 |
| Zone 2 Temp | ° C. | 250 | 100 | 200 |
| Zone 3 Temp | ° C. | 300 | 220 | 280 |
| Zone 4 Temp | ° C. | 300 | 220 | 280 |
| Zone 5 Temp | ° C. | 300 | 220 | 280 |
| Zone 6 Temp | ° C. | 310 | 220 | 280 |
| Zone 7 Temp | ° C. | 320 | 220 | 280 |
| Zone 8 Temp | ° C. | 320 | 220 | 280 |
| Zone 9 Temp | ° C. | 320 | 220 | 280 |
| Zone 10 Temp | ° C. | 320 | 220 | 280 |
| Zone 11 Temp | ° C. | 325 | 220 | 280 |
| Die Temp | ° C. | 330 | 220 | 280 |
| Screw speed | rpm | 300 | 300 | 300 |
| Throughput | kg/hr | 40 | 30 | 30 |

The test specimens were molded with the conditions summarized in Table 3

TABLE 3

| Parameters | Unit | Ex. 1-9 | Ex. 10 | Ex. 11 |
|---|---|---|---|---|
| Cnd: Pre-drying time | Hour | 5 | 4 | 4 |
| Cnd: Pre-drying temp | ° C. | 120 | 100 | 100 |
| Hopper temp | ° C. | 310 | 250 | 280 |
| Zone 1 temp | ° C. | 315 | 250 | 280 |
| Zone 2 temp | ° C. | 320 | 250 | 280 |
| Zone 3 temp | ° C. | 320 | 250 | 280 |
| Nozzle temp | ° C. | 320 | 250 | 290 |
| Mold temp | ° C. | 110 | 80 | 80 |

The dielectric constant (Dk) and dissipation factor (DO were tested at 1.9 GHz using a QWED split post dielectric resonator.

Impact performance (notched or unnotched Izod) was tested according to ASTM D256 using a pendulum energy of 5 lbf/ft at a temperature of 23° C.

Tensile testing was done according to ASTM D638 using a testing speed of 50 mm/min.

Flexural properties were tested according to ASTM D790, using a test specimen having a thickness of 3.2 mm, a span of 100 mm, and a testing speed of 2.54 mm/min.

Table 4 shows compositions and properties for each of the examples. The amount of each component is in weight percent, based on the total weight of the composition.

TABLE 4

| | Ex. | Ex. | Ex. | Ex. | Ex. | Ex. | Ex. | Ex. | Ex. | Ex. | Ex. |
|---|---|---|---|---|---|---|---|---|---|---|---|
| Component | 1* | 2 | 3 | 4* | 5 | 6* | 7 | 8 | 9 | 10* | 11 |
| PPA | 64.5 | 32.15 | 29.65 | 49.7 | 16.5 | 59.5 | 40.8 | 40.8 | 40.8 | | |
| PPE | | 32.15 | 29.65 | | 32.9 | | 9.248 | 4.352 | | | 27.15 |
| PA1010 | | | | | | | | | | 54.5 | 27.15 |
| GF | 35 | 35 | 35 | 50 | 50 | 40 | 40 | 40 | 40 | 45 | 45 |
| AO-1 | 0.2 | | | 0.15 | | 0.2 | | | | 0.2 | |
| AO-2 | 0.2 | | | 0.15 | | 0.2 | | | | 0.2 | |
| Ca Stearate | 0.1 | | | | | 0.1 | | | 0.3 | 0.1 | |
| SEBS | | | 2.5 | | | | 5 | 5 | 5 | | |
| SEP | | | 2.5 | | | | | | | | |
| HIPS | | | | | | | 4.352 | 9.248 | 13.6 | | |
| AO-3 | | 0.15 | 0.15 | | 0.15 | | 0.15 | 0.15 | 0.15 | | 0.15 |
| AO-4 | | 0.15 | 0.15 | | 0.15 | | 0.15 | 0.15 | 0.15 | | 0.15 |
| Citric Acid | | 0.4 | 0.4 | | 0.3 | | 0.3 | 0.3 | | | 0.4 |
| Properties | | | | | | | | | | | |
| Notched Izod | 154 | 89 | 113 | 115 | 46 | 160 | 158 | 150 | 143 | 195 | 88.7 |
| (23° C., | | | | | | | | | | | |
| 5 lbf/ft) | | | | | | | | | | | |
| Unnotched Izod | 1070 | 554 | 588 | 952 | 144 | 1480 | 1280 | 970 | 777 | 1420 | 542 |
| (23° C., | | | | | | | | | | | |
| 5 lbf/ft) | | | | | | | | | | | |
| Flexural | 10 | 9.7 | 10 | 13.5 | 10.6 | 11 | 10.3 | 10.6 | 10.5 | 8.9 | 10 |
| Modulus | | | | | | | | | | | |
| (3.2 mm, | | | | | | | | | | | |
| 1.27 mm/min) | | | | | | | | | | | |
| Tensile | 10.8 | 10.8 | 9.4 | 15 | 13.2 | 12 | 12 | 12 | 11.7 | 10.6 | 11.8 |
| Modulus | | | | | | | | | | | |
| (5 mm/min) | | | | | | | | | | | |
| Tensile | 196 | 181 | 165 | 197 | 79 | 221 | 198 | 186 | 161 | 160 | 167 |
| Strength | | | | | | | | | | | |
| (at break, | | | | | | | | | | | |
| 5 mm/min) | | | | | | | | | | | |
| Tensile | 2.9 | 2.8 | 2.9 | 2.2 | 0.8 | 3.3 | 3.2 | 2.8 | 2.4 | 4.3 | 3.4 |
| Elongation | | | | | | | | | | | |
| (at break, | | | | | | | | | | | |
| 5 mm/min) | | | | | | | | | | | |
| Dk (1.9 GHz) | 3.4 | 3.15 | 3.10 | 3.58 | 3.29 | 3.46 | 3.27 | 3.29 | 3.27 | 3.27 | 3.21 |
| Df (1.9 GHz) | 0.0116 | 0.0076 | 0.0073 | 0.011 | 0.0059 | 0.011 | 0.0082 | 0.0083 | 0.0082 | 0.0104 | 0.007 |

*Indicates a comparative example

Examples 2-3 of Table 4 are representative formulations of glass fiber-reinforced polyphthalamide-containing compositions including PPE and impact modifiers. Compared to the glass fiber reinforced PA6T/66 composite of Comparative Example 1, the addition of PPE (1:1 ratio of PA6T/66 to PPE) in the formulation of Example 2 decreased the Dk and Df values significantly. Most of mechanical properties were maintained. In order to improve the impact performance of Example 2, 5 wt % impact modifier was added in the formulation of Example 3, and the notched impact strength was improved by about 27% compared to that of Example 2. The Dk and Df values also further decreased for Example 3.

Example 5 of Table 4 is a representative formulation of a glass fiber-reinforced polyphthalamide/polyphenylene ether blend. As shown in Table 4, the dielectric and mechanical performance was altered with the addition of PPE (1:2 ratio of PPA to PPE) in the formulation with 50% loading level of low Dk/Df glass fiber of Example 5. Dk decreased by 0.29 and Df decreased by about 46%, which indicates that the addition of PPE decreased Dk/Df performance at high glass fiber loading. The mechanical performance of Example 5 was sufficient to meet the requirements of some specific applications.

Examples 7-9 of Table 4 are representative formulations of glass fiber-reinforced polyphthalamide and polyphthalamide/polyphenylene ether/HIPS compositions. As shown in Table 4, the dielectric and mechanical performance changed with the addition of HIPS in the PPA/PPE based formulations with 40% loading level of low Dk/Df glass fiber. The addition of HIPS and PPE led to the same effect as the addition of PPE in PPA-based glass fiber reinforced composite, while maintaining the mechanical properties (see, e.g., Examples 7 and 8 compared to Comparative Example 6. If HIPS replaced PPE completely, as in Example 9, Dk and Df was observed to be similar as for PPE/HIPS blends of Examples 7 or 8. The date shown in Table 4 indicates that HIPS can also help to decrease Dk/Df while maintaining good mechanical properties when used in a certain range.

Examples 10 and 11 show the dielectric and mechanical performance change with the addition of PPE (1:1 ratio of PA1010 to PPE) in the formulation with 45% loading level of low Dk/Df glass fiber. Dk was decreased by 0.06 and Df decreased by about 33% for Example 11, which indicates that the addition of PPE can decrease Dk/Df in PA1010 composites as well. The mechanical performance of Example 11 was sufficient to meet the requirements of some specific applications.

This disclosure further encompasses the following aspects.

Aspect 1: A reinforced composition comprising 40 to 80 weight percent of a compatibilized blend comprising a polyamide, a polyphenylene ether, a functionalizing agent in an amount sufficient to effect compatibilization, and optionally, a high impact polystyrene, wherein a weight ratio of the polyamide to the polyphenylene ether and the high impact polystyrene is 1:2 to 3:1; and 20 to 60 weight of glass fibers having a dielectric constant of less than 5.0 at a frequency of 1 MHz to 1 GHz and a dissipation factor of less than 0.002 at a frequency of 1 MHz to 1 GHz; wherein weight percent of each component is based on the total weight of the composition; and wherein the composition has a dielectric constant of less than 4 at a frequency of 1 MHz to 5 GHz and a dissipation factor of less than 0.012 at a frequency of 1 MHz to 5 GHz.

Aspect 2: The reinforced composition of aspect 1, wherein the compatibilized blend comprises the polyamide and the polyphenylene ether, preferably wherein the compatibilized blend comprises 20 to 60 weight percent of the polyamide and 10 to 40 weight percent of the polyphenylene ether.

Aspect 3: The reinforced composition of aspect 11, wherein the compatibilized blend comprises the polyamide, the polyphenylene ether, and the high impact polystyrene, preferably wherein the compatibilized blend comprises 20 to 60 weight percent of the polyamide, 1 to 39 weight percent of the polyphenylene ether, and 1 to 20 weight percent of the high impact polystyrene.

Aspect 4: The reinforced composition of any of aspects 1-3, wherein the functionalizing agent comprises citric acid, maleic anhydride, or fumaric acid, preferably wherein the functionalizing agent is citric acid.

Aspect 5: The reinforced composition of any of aspects 1-4, wherein the functionalizing agent is used in an amount of 0.2 to 0.9 weight percent, based on the total weight of the composition.

Aspect 6: The reinforced composition of any of aspects 1-5, wherein the polyamide is a polyphthalamide.

Aspect 7: The reinforced composition of any of aspects 1-5, wherein the polyamide is a poly(C₁₋₁₂ alkylene dicarboxylate).

Aspect 8: The reinforced composition of any of aspects 1-8, wherein the polyphenylene ether comprises a poly(2,6-dimethyl-1,4-phenylene ether).

Aspect 9: The reinforced composition of any one or more of aspects 1 to 4, further comprising 0.1 to 10 weight percent of an impact modifier.

Aspect 10: The reinforced composition of aspect 9, wherein the impact modifier comprises a hydrogenated block copolymer of an alkenyl aromatic monomer and a conjugated diene.

Aspect 11: The reinforced composition of aspect 10, wherein the hydrogenated block copolymer is a polystyrene-poly(ethylene-butylene)-polystyrene triblock copolymer, a polystyrene-poly(ethylene-propylene) diblock copolymer, or a combination thereof.

Aspect 12: The reinforced composition of any of aspects 1-11, further comprising an antioxidant, heat stabilizer, light stabilizer, ultraviolet light stabilizer, ultraviolet light absorbing additive, plasticizer, lubricant, release agent, processing aid, antistatic agent, anti-fog agent, antimicrobial agent, colorant, surface effect additive, radiation stabilizer, flame retardant, anti-drip agent, hydrostabilizer, or a combination comprising at least one of the foregoing, preferably, an antioxidant, heat stabilizer, hydrostabilizer, ultraviolet light stabilizer, processing aid, or a combination comprising at least one of the foregoing.

Aspect 13: A method for the manufacture of the reinforced composition of any one or more of aspects 1 to 12, the method comprising melt-mixing the components of the reinforced composition; and optionally, extruding the reinforced composition.

Aspect 14: An article comprising the reinforced composition of any one or more of aspects 1 to 12.

Aspect 15: The article of aspect 14, wherein the article is an injection molded article, an extruded article, or a compression molded article.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, unsaturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo groups (e.g., bromo and fluoro), or only chloro groups can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl)a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A reinforced composition comprising
40 to 80 weight percent of a compatibilized blend
comprising a polyamide;
a polyphenylene ether, a high impact polystyrene or a combination thereof; and
a functionalizing agent in an amount sufficient to effect compatibilization; wherein a weight ratio of the polyamide to the polyphenylene ether and the high impact polystyrene is 1:2 to 3:1; and
20 to 60 weight of glass fibers having a dielectric constant of less than 5.0 at a frequency of 1 MHz to 1 GHz and a dissipation factor of less than 0.002 at a frequency of 1 MHz to 1 GHz;
wherein weight percent of each component is based on the total weight of the composition; and
wherein the composition has a dielectric constant of less than 4 at a frequency of 1 MHz to 5 GHz and a dissipation factor of less than 0.012 at a frequency of 1 MHz to 5 GHz.

2. The reinforced composition of claim 1, wherein the compatibilized blend comprises the polyamide and the polyphenylene ether.

3. The reinforced composition of claim 1, wherein the compatibilized blend comprises the polyamide, the polyphenylene ether, and the high impact polystyrene.

4. The reinforced composition of claim 1, wherein the functionalizing agent comprises citric acid, maleic anhydride, or fumaric acid.

5. The reinforced composition of claim 1, wherein the functionalizing agent is used in an amount of 0.2 to 0.9 weight percent, based on the total weight of the composition.

6. The reinforced composition of claim 1, wherein the polyamide is a polyphthalamide.

7. The reinforced composition of claim 1, wherein the polyamide is a poly(C1-12 alkylene dicarboxylate).

8. The reinforced composition of claim 1, wherein the polyphenylene ether comprises a poly(2,6-dimethyl-1,4-phenylene ether).

9. The reinforced composition of claim 1, further comprising 0.1 to 10 weight percent of an impact modifier.

10. The reinforced composition of claim 9, wherein the impact modifier comprises a hydrogenated block copolymer of an alkenyl aromatic monomer and a conjugated diene.

11. The reinforced composition of claim 10, wherein the hydrogenated block copolymer is a polystyrene-poly(ethylene-butylene)-polystyrene triblock copolymer, a polystyrene poly(ethylene-propylene) diblock copolymer, or a combination thereof.

12. The reinforced composition of claim 1,
further comprising
an antioxidant, heat stabilizer, light stabilizer, ultraviolet light stabilizer, ultraviolet light absorbing additive, plasticizer, lubricant, release agent, processing aid, antistatic agent, anti-fog agent, antimicrobial agent, colorant, surface effect additive, radiation stabilizer, flame retardant, anti-drip agent, hydrostabilizer, or a combination comprising at least one of the foregoing.

13. A method for the manufacture of the reinforced composition of claim 1, the method comprising
melt-mixing the components of the reinforced composition; and
optionally, extruding the reinforced composition.

14. An article comprising the reinforced composition of claim 1.

15. The article of claim 14, wherein the article is an injection molded article, an extruded article, or a compression molded article.
